(19) United States
(12) Patent Application Publication
(10) Pub. No.: US 2016/0378445 A1
(43) Pub. Date: Dec. 29, 2016

(54) SIMILARITY DETERMINATION APPARATUS, SIMILARITY DETERMINATION METHOD AND SIMILARITY DETERMINATION PROGRAM

(71) Applicant: MITSUBISHI ELECTRIC CORPORATION, Tokyo (JP)

(72) Inventors: Ryo KASHIWAGI, Tokyo (JP); Katsuhiko NAKAMURA, Tokyo (JP); Natsuko FUJII, Tokyo (JP); Takamitsu YAMADA, Tokyo (JP); Yuki HIKAWA, Tokyo (JP)

(73) Assignee: MITSUBISHI ELECTRIC CORPORATION, Tokyo (JP)

(21) Appl. No.: 14/958,074

(22) Filed: Dec. 3, 2015

(30) Foreign Application Priority Data
Jun. 26, 2015 (JP) 2015-128268

(51) Int. Cl. G06F 9/45; G06F 9/44; G06F 17/30

(52) U.S. Cl. CPC G06F 8/433; G06F 17/30424; G06F 8/77; G06F 8/42

(57) ABSTRACT

An objective is to extract, as similar functions, not only a pair of functions having the same syntax, but also a pair of functions having different syntaxes but performing similar processes. A similarity determination apparatus includes: a dependency analyzing section to get a list of dependee elements as a dependency list, from a source code including a plurality of functions, each function depending on one of the dependee elements; a similarity calculating section to calculate, based on the dependency list, similarity between the dependee elements on which two of the plurality of functions depend, as dependee similarity, and calculate, based on the calculated dependee similarity. similarity between the two functions, as depender similarity; and a similarity threshold determining section to determine that the two functions are similar to each other when the depender similarity is equal or exceeds a first threshold.

### CROSS-REFERENCE TO RELATED APPLICATIONS

This application is based on and claims the benefit of priority from Japanese Patent Application No. 2015-128268, filed in Japan on Jun. 26, 2015, the content of which is incorporated herein by reference in its entirety.

### TECHNICAL FIELD

The present invention relates to a similarity determination apparatus, a similarity determination method and a similarity determination program which are designed to determine similarity between functions based on a source code of a program, and more particularly, which are designed to evaluate similarity between functions and measure similarity information quantitatively.

### BACKGROUND ART

It is common in large-scale system development to recycle program components of existing systems in order to save man-hours. Specifically, a source code in a recycled program component is copied and pasted to produce a pair of identical code fragments, and a copied-and-pasted source code is modified to produce a pair of similar code fragments.

Referring to such a pair of similar code fragments, if one of the pair of code fragments needs to be modified, it is highly likely that the counterpart code fragment also needs to be modified. For this reason, when there is a pair of similar code fragments, it is necessary to identify the pair of similar code fragments before the program is upgraded.

Further, when upgrading a program including a plurality of pairs of similar code fragments, the problem is that if the plurality of pairs of similar code fragments are modified separately, the time required for modification is increased to boost maintenance costs. A solution to this problem is to integrate the similar code fragments into a single code fragment through refactoring to improve the internal structure of the source code. This method requires identifying a pair of similar code fragments to be refactored.

However, it is inefficient in large-scale system development to visually search a large amount of source code for a pair of similar code fragments, which results in an increase in the number of man-hours. Furthermore, visual searching would end up overlooking of a pair of similar code fragments, which will result in a failure to modify the pair of similar code fragments to be modified. This becomes a factor for failure. Given this fact, it is required in a large-scale system development site to detect pairs of similar code fragments efficiently and exhaustively.

Patent Document 1, Patent Document 2, Patent Document 3 and Non-Patent Document 1 describe a method or a tool for automatically detecting a pair of similar code fragments in a source code which is composed of a plurality of text files.

Non-Patent Document 1 describes CCFinder which is a tool for detecting pairs of similar code fragments. CCFinder uses lexical analysis to detect pairs of similar code fragments. Specifically, CCFinder converts a function name and a variable identifier into a token string, then replaces it with a specific character string, and analyses the character string. Therefore, CCFinder can detect a pair of code fragments whose syntaxes are similar to each other, irrespective of differences in the function name and the variables identifier.

Patent Document 1 describes a method of detecting pairs of similar code fragments based on the detection tool described in Non-Patent Document 1 in conjunction with comparison between character strings.

Patent Document 2 describes a method in which a pair of similar code fragments is detected based on the detection method described in Patent Document 1 or Non-Patent Document 1, or the like, and also in which complexity information through static analysis is presented as information for selecting a pair of code fragments to be refactored.

Patent Document 3 describes a method of reducing erroneous detection by identifying a memory to be referred to by each of a pair of similar code fragments detected through lexical analysis.

### CITATION LIST

### Patent Literature

Patent Document 1: JP 2003-216425 A
Patent Document 2: JP 2012-164211 A
Patent Document 3: JP 2011-096082 A

### Non-Patent Literature

Non-Patent Document 1: Toshihiro KAMIYA; CCFinder Official Site; URL: http://www.ccfinder.net/index-j.html

### SUMMARY OF INVENTION

### Technical Problem

Patent Document 1, Patent Document 2, Patent Document 3 and Non-Patent Document 1 describe methods of detecting pairs of similar code fragments based on lexicon analysis or syntax difference. Therefore, a pair of similar code fragments having the same syntax can be detected, but the problem is that a pair of similar code fragments having different syntaxes cannot be detected.

Furthermore, existing methods use syntax pattern matching to detect similar code fragments. Specifically, a minimum number of tokens, or a pattern length, to indicate that the code fragments are similar to each other is specified. The problem is however that if the number of tokens specified by a user is too small, an error can get mixed in easily with the detection result, and if the number of tokens specified by a user is too large, then a short code fragment or a modified code fragment which have changed the syntax pattern cannot be detected.

An objective of the present invention is to detect not only a pair of similar code fragments having the same syntax but also a pair of similar code fragments having different syntaxes, and also detect a pair of similar code fragments without adjusting the number of tokens.

### Solution to Problem

A similarity determination apparatus according to the present invention may include:

a dependency analyzing section to get a list of dependee elements as a dependency list, from a source code including a plurality of functions, each of the plurality of functions depending on one of the dependee elements;

a similarity calculating section to calculate, based on the dependency list, similarity between dependee elements on which two of the plurality of functions depend, as dependee similarity, and calculate, based on the dependee similarity, similarity between the two functions, as depender similarity; and

a similarity threshold determining section to determine that the two functions are similar to each other when the depender similarity is equal or exceeds a first threshold.

### Advantageous Effects of Invention

According to a similarity determination apparatus according to the present invention, a similarity calculating section calculates, based on a dependency list, similarity between dependee elements on which two of a plurality of functions depend, as dependee similarity; and calculates, based on the dependee similarity, similarity between the two functions, as depender similarity. A similarity threshold determining section determines that the two functions are similar to each other when the depender similarity is equal or exceeds a first threshold. Therefore, according to this invention, not only the two functions whose syntaxes are the same, but also the two functions whose syntaxes are different from each other, but the dependees on which they depend are similar to each other, can be determined to be similar.

### BRIEF DESCRIPTION OF DRAWINGS

The present invention will become fully understood from the detailed description given hereinafter in conjunction with the accompanying drawings, in which:

FIG. 1 illustrates a block configuration of a similarity determination apparatus 100 according to a first embodiment;

FIG. 2 is a flow chart illustrating a similarity determination method 9100 performed by the similarity determination apparatus 100, and a similarity determination process S100 performed by a similarity determination program 9200, according to the first embodiment;

FIG. 3 illustrates a source code 111 to be processed by the similarity determination apparatus 100, a property 112 of the source code 111, and detection results 113 by a method of a comparison example, according to the first embodiment;

FIG. 4 illustrates an example of a dependency list 131 according to the first embodiment;

FIG. 5 illustrates an example of metrics information 151 according to the first embodiment;

FIG. 6 is a flow chart illustrating a similarity determination execution process S130 performed by a similarity determination executing section 160, according to the first embodiment;

FIG. 7 illustrates an example of a similarity determination threshold 171 according to the first embodiment;

FIG. 8 illustrates an example of a dependee similarity list 1611 according to the first embodiment;

FIG. 9 is a flow chart illustrating a dependee similarity calculation process S131 performed by the similarity calculating section 161, according to the first embodiment;

FIG. 10 illustrates an example of a depender similarity list 1612 according to the first embodiment;

FIG. 11 is a flow chart illustrating a depender similarity calculation process S132 performed by the similarity calculating section 161, according to the first embodiment;

FIG. 12 illustrates an example of a metrics similarity list 1613 according to the first embodiment;

FIG. 13 illustrates another example of the metrics similarity list 1613 according to the first embodiment;

FIG. 14 is a flow chart illustrating a metrics similarity calculation process S133 performed by the similarity calculating section 161, according to the first embodiment;

FIG. 15 illustrates an example of a similar function list 180 according to the first embodiment;

FIG. 16 is a flow chart illustrating a similarity threshold determination process S134 performed by the similarity threshold determining section 162, according to the first embodiment;

FIG. 17 illustrates a block configuration of a similarity determination apparatus 100a according to a second embodiment;

FIG. 18 illustrates an example of an acceptable disagreement number 191 according to the second embodiment;

FIG. 19 is a flow chart illustrating a dependee similarity calculation process S131a performed by a similarity calculating section 161a, according to the second embodiment;

FIG. 20 illustrates an example of the dependee similarity list 1611 according to the second embodiment;

FIG. 21 illustrates an example of the depender similarity list 1612 according to the second embodiment;

FIG. 22 illustrates an example of the similar function list 180 according to the second embodiment; and

FIG. 23 illustrates a hardware configuration for the similarity determination apparatuses 100 and 100a according to the first and second embodiments.

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

### Embodiment 1

### Description of Configuration

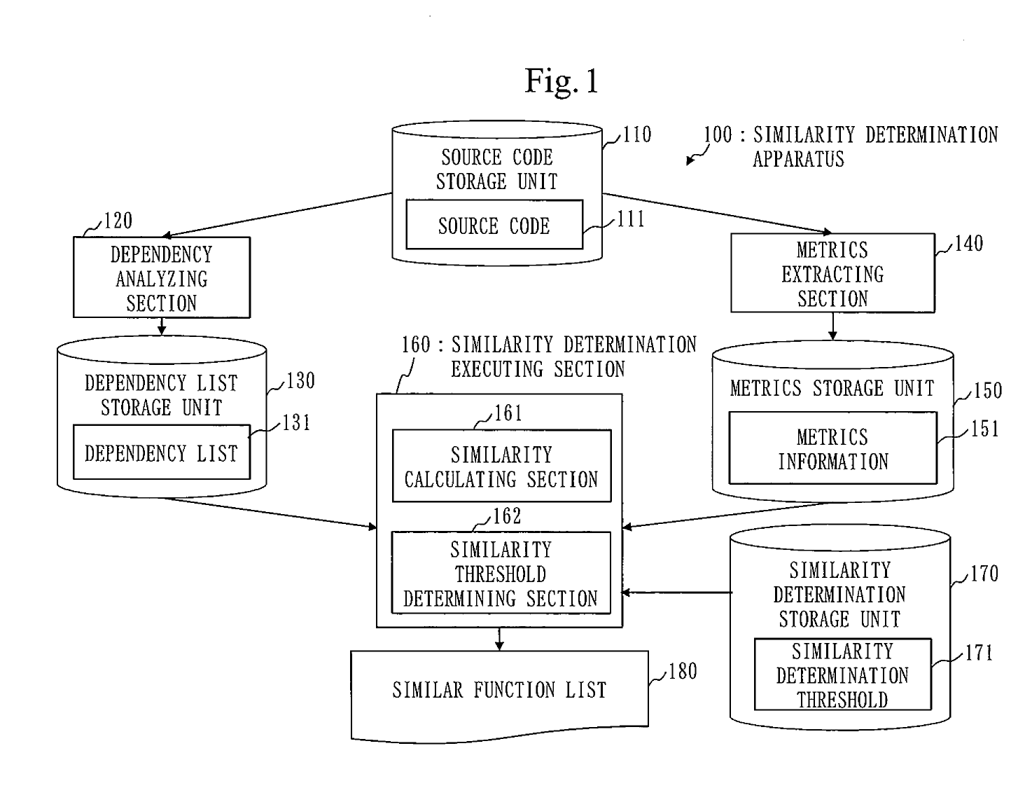

A block configuration of a similarity determination apparatus 100 according to a first embodiment is discussed below with reference to FIG. 1.

Referring to FIG. 1, the similarity determination apparatus 100 includes a dependency analyzing section 120 (analyzer), a metrics extracting section 140 (extractor), and a similarity determination executing section 160. The similarity determination apparatus 100 is also provided with a source code storage unit 110, a dependency list storage unit 130, a metrics storage unit 150 and a similarity determination storage unit 170.

The source code storage unit 110 stores a source code 111 which is searched for similar functions to be detected. The dependency list storage unit 130 stores a dependency list 131 which is outputted from the dependency analyzing section 120. The metrics storage unit 150 stores metrics information 151 which is outputted from the metrics extracting section 140. The similarity determination storage unit 170 stores a similarity determination threshold 171 which is used for determining similar functions.

The dependency analyzing section 120 gets a list of dependee elements as a dependency list 131, from the source code 111 including a plurality of functions, each function depending on one of the dependee elements, where the term “dependee” indicates a destination of dependency.

The metrics extracting section 140 extracts, from the source code 111, metrics which indicate a quantified property of one of the plurality of functions, as the metrics information 151. The metrics indicating a quantified property of one of the plurality of functions are also called implementation metrics.

The similarity determination executing section 160 includes a similarity calculating section 161 (calculator) and a similarity threshold determining section 162 (determiner). The similarity calculating section 161 calculates, based on the dependency list 131, similarity between dependee elements on which two of the plurality of functions depend, as dependee similarity. Specifically, the similarity calculating section 161 determines whether or not names of the dependee elements on which the two functions depend are similar, and whether or not dependency types of the two functions agree. Based on the determination results and a dependent strength indicating a level of dependency, the similarity calculating section 161 calculates the dependee similarity. Then, based on the calculated dependee similarity, the similarity calculating section 161 calculates similarity between the two functions, as depender similarity, where the term “depender” indicates a source of dependency.

The similarity calculating section 161 also calculates, based on the metrics information 151, similarity between the properties of the two functions, as metrics similarity.

The similarity determination storage unit 170 stores a first threshold 17111 and a second threshold 17121, as the similarity determination threshold 171.

The similarity threshold determining section 162 determines that the two functions are similar functions which are similar to each other when the depender similarity is equal or exceeds the first threshold 17111, and the metrics similarity is equal or exceeds the second threshold 17121. Alternatively, the similarity threshold determining section 162 may determine that the two functions are similar to each other when the depender similarity is equal or exceeds the first threshold 17111. It is also possible that the similarity threshold determining section 162 determines that the two functions are similar to each other when the metrics similarity is equal or exceeds the second threshold 17121.

The similarity threshold determining section 162 sets in a similar function list 180 the two functions which have been determined to be similar to each other.

The similarity determination apparatus 100 is also called a similar-function detection apparatus to detect two functions which are similar to each other.

***Description of Operation***

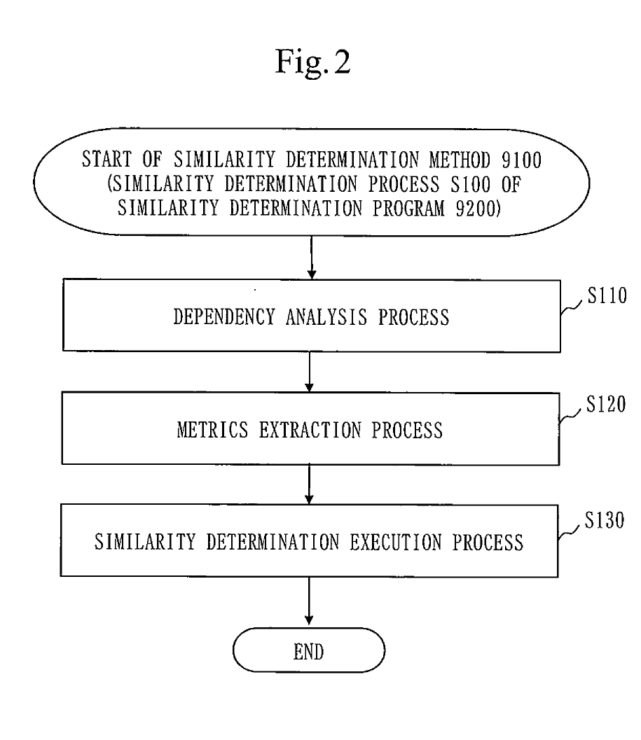

A similarity determination method 9100 performed by the similarity determination apparatus 100, and a similarity determination process S100 executed by a similarity determination program 9200, of this embodiment, are discussed below with reference to FIG. 2. The similarity determination program 9200 causes the similarity determination apparatus 100 as a computer to execute the similarity determination process S100.

<Dependency Analysis Process S110>

The dependency analyzing section 120 performs the dependency analysis process S110 to get the list of dependee elements, as the dependency list 131b, from the source code 111 including a plurality of functions, each function depending on one of the dependee elements.

Specifically, the dependency analyzing section 120 gets the dependency list 131, using the source code 111. The dependency analyzing section 120 outputs a dependency data combination including the depender element, the dependee element, the dependency type and the dependent strength, to the dependency list 131. The dependency analyzing section 120 gets the dependency list 131, using a tool to get the dependency list 131. More specifically, this tool, upon receipt of the source code 111, outputs the dependency list 131 corresponding to the inputted source code 111.

The dependency analyzing section 120 stores the obtained dependency list 131 in the dependency list storage unit 130.

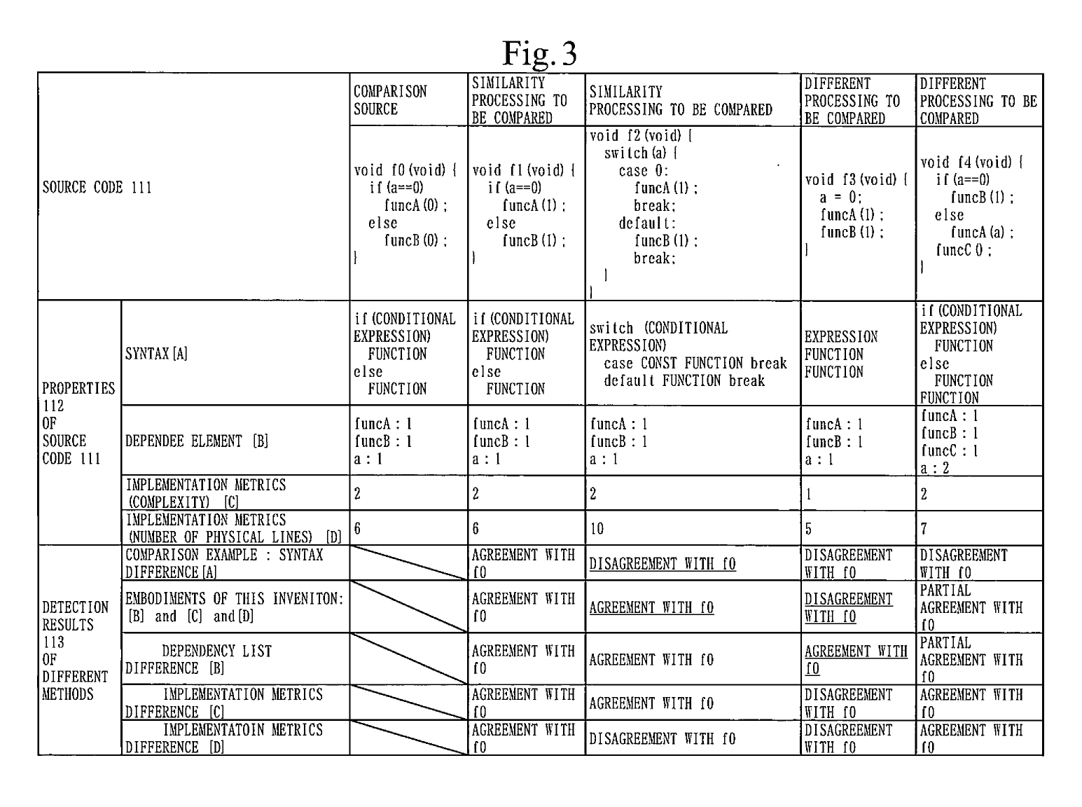

FIG. 3 illustrates the source code 111 to be processed by the similarity determination apparatus 100 of this embodiment, properties 112 of the source code 111, and detection results 113 by a method of a comparison example to be compared with this embodiment.

It is assumed that the source code 111 of FIG. 3 is to be processed by the similarity determination process S100, for example.

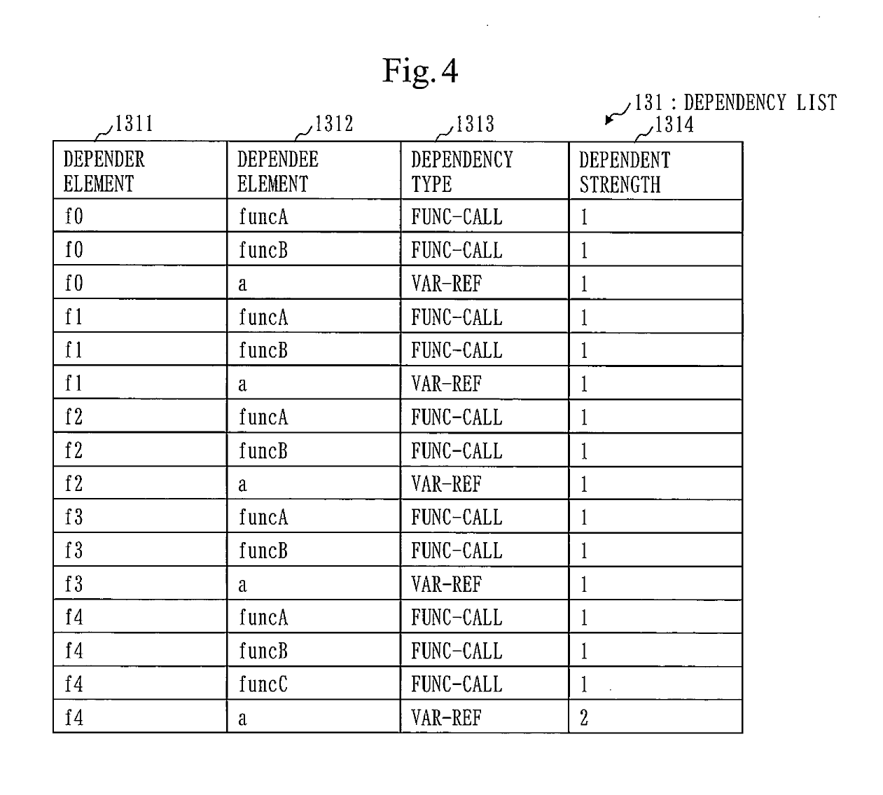

An example of the dependency list 131 of this embodiment is discussed below with reference to FIG. 4.

The dependency list 131 includes: a dependee element 1312 on which one of a plurality of functions “f0”, “f1”, “f2”, “f3” and “f4” depends; a dependency type 1313 indicating a type of the dependee element 1312; and a dependent strength 1314 indicating a level of dependency of one of the plurality of functions on the dependee element 1312.

Referring to FIG. 4, the dependency list 131 shows output results from the dependency analyzing section 120, for the plurality of functions “f0”, “f1”, “f2”, “f3” and “f4” described in the source code 111 in FIG. 3.

A depender element 1311 is one of the functions descried in the source code 111, which is to be processed for similarity determination.

The dependee element 1312 is the element on which the function of the depender element 1311 depends.

The dependency type 1313 indicates a type of dependency between the depender element 1311 and the dependee element 1312. Specifically, in FIG. 3, the dependency type of a dependee element “funcA” is Function-Call (FUNC-CALL) since the corresponding depender element “f0” is to depend on a function. The dependency type of a dependee element “a” is Variable-Reference (VAR-REF) since the corresponding depender element “f0” is to depend on a variable.

The dependent strength 1314 indicates the number of times the depender element 1311 has referred to the dependee element 1312. Specifically, when the depender element “f0” has referred to the dependee element “funcA” just once, the dependent strength is set to 1. When the depender element “f4” has referred to the dependee element “a” twice, the dependent strength is set to 2.

<Metrics Extraction Process S120>

The metrics extracting section 140 performs the metrics extraction process S120 to extract from the source code 111 metrics which indicate a quantified property of one of the plurality of functions, as the metrics information 151. The metrics extracting section 140 extracts from the source code 111 the metrics information 151 including complexity 1511 and the number of physical lines 1512, of one of the plurality of functions, as metrics. The metrics indicating a property of a function, however, are not to be limited to such quantified properties of complexity 1511 and a number of physical lines 1512 of a function, and may be any numerical value other than those described, instead.

The metrics extracting section 140 gets the metrics information 151 about the source code 111. The metrics extracting section 140 outputs information on such as the complexity 1511 and the number of physical lines 1512, of each function included in the source code 111, as the metrics information 151. The metrics extracting section 140 gets the metrics information 151, using a tool to get the metrics information 151. More specifically, this tool, upon receipt of the source code 111, outputs the metrics information 151 corresponding to the inputted source code 111.

The metrics extracting section 140 stores the obtained metrics information 151 in the metrics storage unit 150.

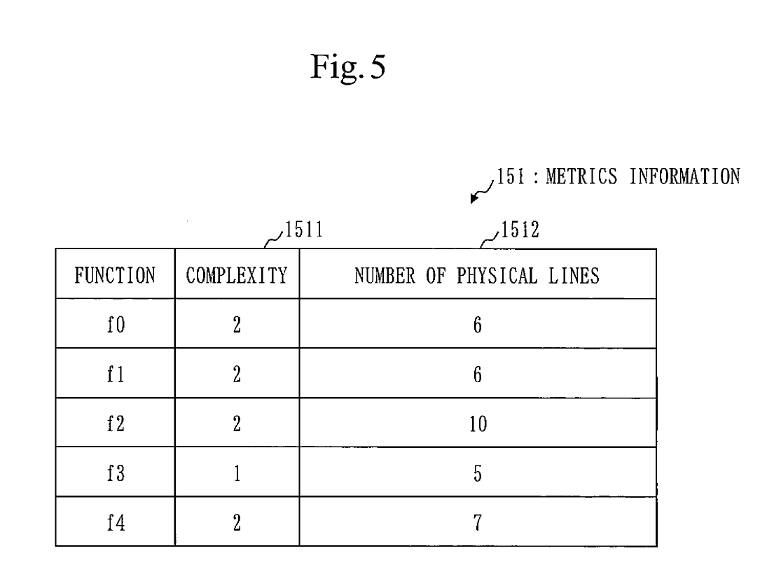

An example of the metrics information 151 of this embodiment is discussed below with reference to FIG. 5. FIG. 5 illustrates the metrics information 151 of the plurality of functions “f0”. “f1”, “f2”, “f3” and “f4” described in the source code 111 in FIG. 3.

In the metrics information 151, different kinds of metrics are set for each function included in the source code 111. The different kinds of metrics are the complexity 1511 and the number of physical lines 1512, for example.

<Similarity Determination Execution Process S130>

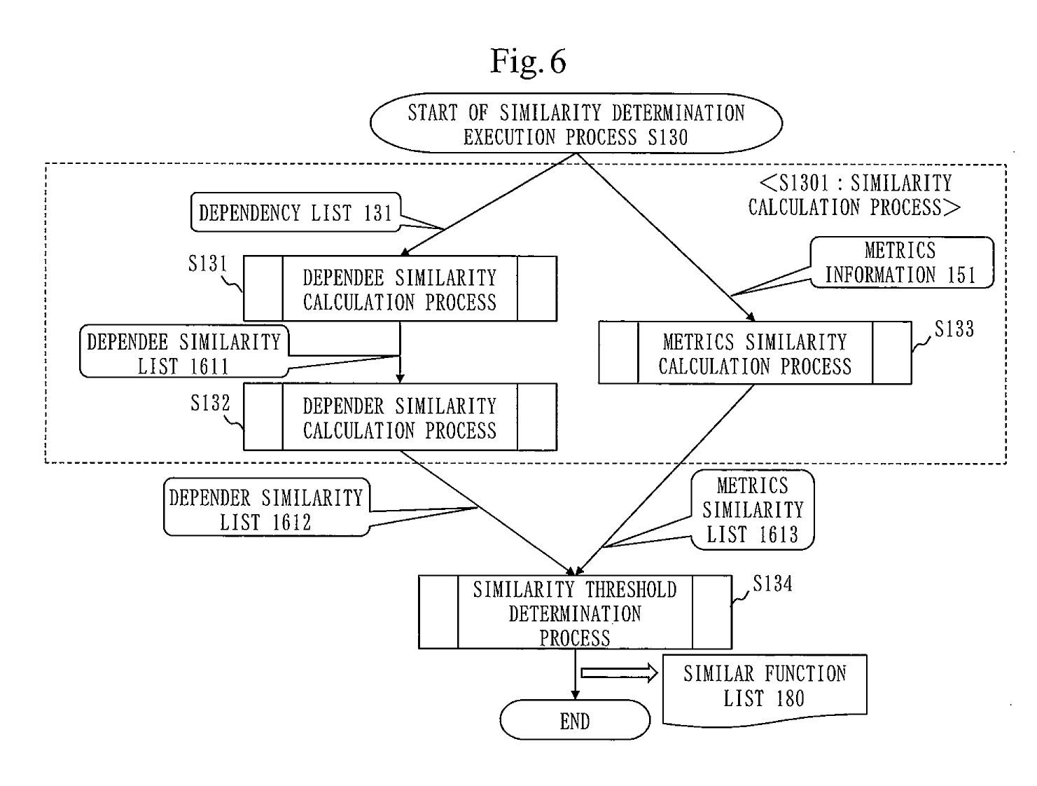

The similarity determination execution process S130 performed by the similarity determination executing section 160 of this embodiment is outlined below with reference to FIG. 6.

The similarity determination executing section 160 outputs a pair of functions from the source code 111 to the similar function list 180, as similar functions, based on the dependency list 131 and the metrics information 151, when similarity between the function pair exceeds the similarity determination threshold 171. It is to be noted that two of the plurality of functions may be called a pair of functions.

The similarity determination execution process S130 includes a similarity calculation process S1301 and a similarity threshold determination process S134.

The similarity calculation process S1301 includes the dependee similarity calculation process S131, a depender similarity calculation process S132 and a metrics similarity calculation process S133.

In S131, the similarity calculating section 161 calculates, based on the dependency list 131, similarity between dependee elements on which the two of the plurality of functions depend, as dependee similarity 16111.

The similarity calculating section 161 performs the dependee similarity calculation process S131 based on the dependency list 131, and outputs a dependee similarity list 1611. The dependee similarity list 1611 shows calculated dependee similarity 16111 for a pair of different dependency data combinations in the dependency list 131.

The similarity calculating section 161 determines whether or not the names of the dependee elements on which the two functions depend are similar to each other, and whether or not the dependency types of the two functions agree, and calculates the dependee similarity 16111 based on the determination results and the dependent strength.

In S132, the similarity calculating section 161 calculates similarity between the two functions as depender similarity 16121 based on the dependee similarity 16111 in the dependee similarity list 1611.

The similarity calculating section 161 performs the depender similarity calculation process S132 based on the dependee similarity list 1611, and outputs depender similarity list 1612. The depender similarity list 1612 shows calculated depender similarity 16121 for a pair of different functions.

In S133, the similarity calculating section 161 calculates similarity between the properties of the two functions based on the metrics information 151, as metrics similarity 16131.

The similarity calculating section 161 performs the metrics similarity calculation process S133 based on the metrics information 151, and outputs the metrics similarity list 1613 including the metrics similarity 16131.

In the similarity threshold determination process S134, the similarity threshold determining section 162 determines that the two functions are similar to each other when the depender similarity 16121 is equal or exceeds the first threshold 17111 and the metrics similarity 16131 is equal or exceeds the second threshold 17121. Alternatively, the similarity threshold determining section 162 may determine that the two functions are similar when the depender similarity 16121 is equal or exceeds the first threshold 17111. It is also possible that the similarity threshold determining section 162 determines that the two functions are similar to each other when the metrics similarity 16131 is equal or exceeds the second threshold 17121. In other words, the similarity threshold determining section 162 may perform similarity determination based both on the depender similarity 16121 and the metrics similarity 16131, or based only on one of them.

According to this embodiment, the similarity threshold determining section 162 performs the similarity threshold determination process S134 based on the depender similarity list 1612, the metrics similarity list 1613 and the similarity determination threshold 171, and outputs the similar function list 180.

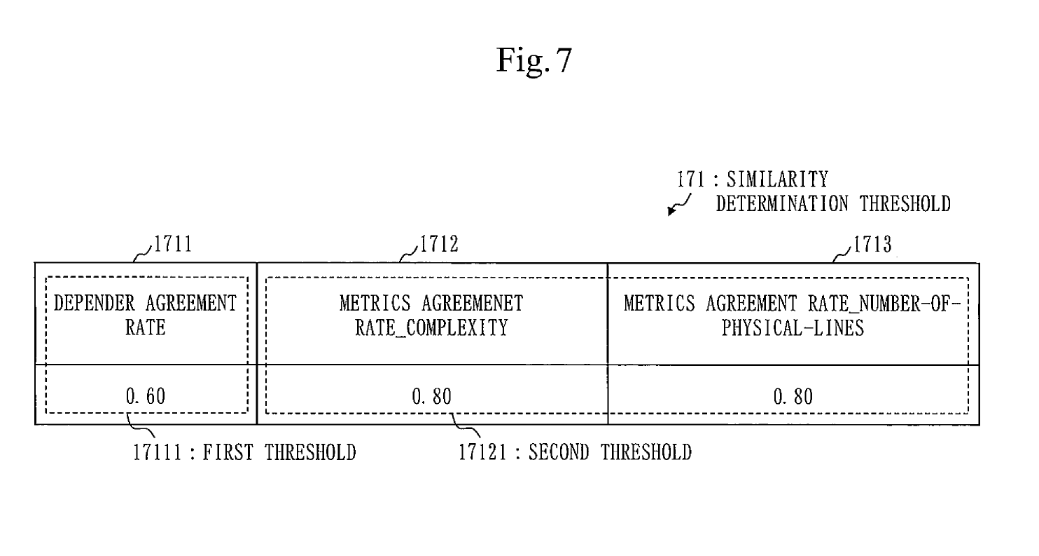

An example of the similarity determination threshold 171 of this embodiment is discussed below with reference to FIG. 7. The similarity determination threshold 171 includes a depender agreement rate 1711 which is a threshold for the agreement rate of depender similarity, and metrics agreement rates 1712 and 1713 which are thresholds for the agreement rate of metrics for each kind.

The depender similarity 16121 indicates a quantified similarity between functions of the depender, for the dependee element, the dependency type, and the dependent strength.

Referring to FIG. 7, the depender agreement rate 1711, the metrics agreement rate 1712 for complexity, and the metrics agreement rate 1713 for the number of physical lines are set in the similarity determination threshold 171.

The depender agreement rate 1711 is an example of the first threshold 17111.

The metrics agreement rate 1712 for complexity and the metrics agreement rate 1713 for the number of physical lines are examples of the second threshold 17121.

The similarity determination execution process S130 performed by the similarity determination executing section 160 is discussed below in more detail.

<Dependee Similarity Calculation Process S131>

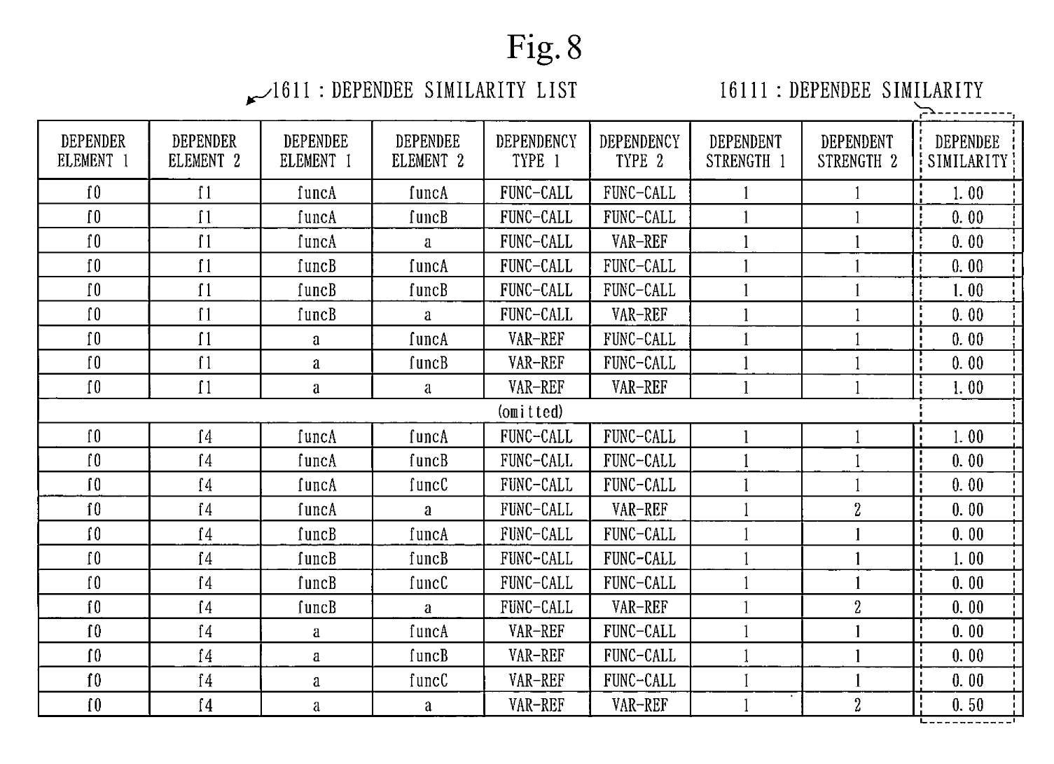

FIG. 8 illustrates an example of the dependee similarity list 1611 of this embodiment.

In the dependee similarity list 1611, depender element 1, depender element 2, dependee element 1, dependee element 2, dependency type 1, dependency type 2, dependent strength 1, dependent strength 2, and the dependee similarity 16111 are set.

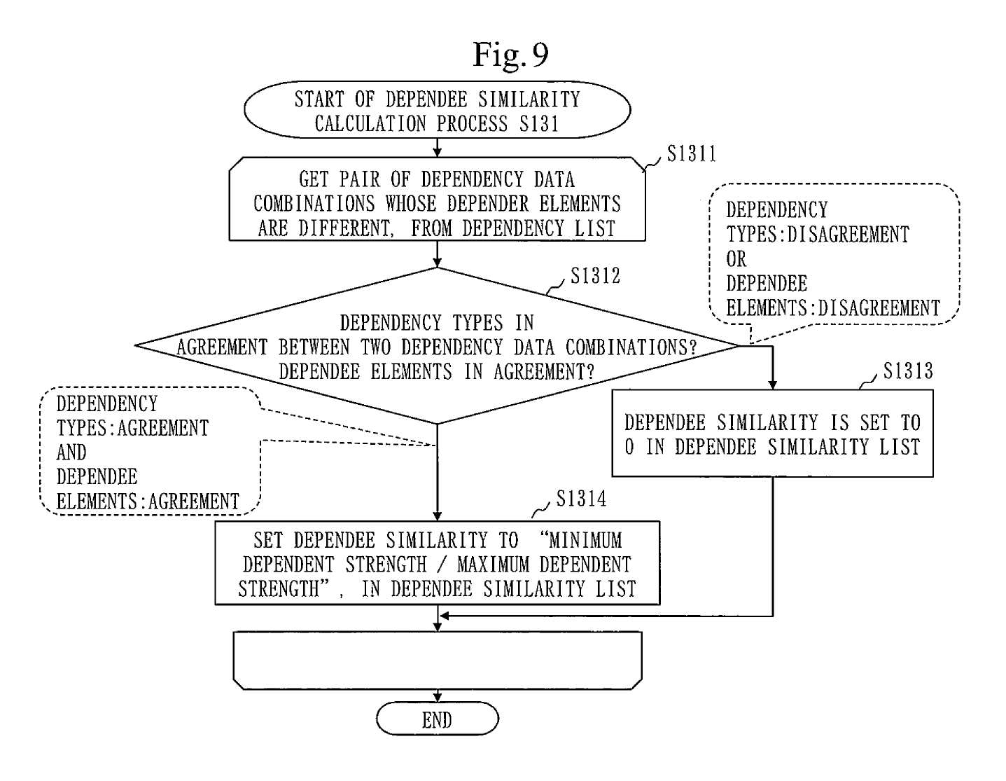

The dependee similarity calculation process S131 performed by the similarity calculating section 161 of this embodiment is discussed below with reference to FIG. 9.

FIG. 9 illustrates a processing flow of the dependee similarity calculation process S131.

In S1311, the similarity calculating section 161 gets a pair of dependency data combinations having different depender elements, in the dependency list 131. Referring to the dependee similarity list 1611 in FIG. 8, a pair of “funcA” for the dependee element 1 and “funcA” for the dependee element 2, which correspond to “f0” and “f1” of depender elements, respectively, is obtained. In a combined dependency data combination of this pair, the dependency type 1 is set to Function-Call, the dependency type 2 is set to Function-Call, the dependent strength 1 is set to 1, and the dependent strength 2 is set to 1, based on the dependency list 131.

The similarity calculating section 161 determines whether or not the names of the dependee elements on which the two functions depend are similar to each other, and whether or not the dependency types of the two functions agree. Then, based on the determination results and the dependent strength, the similarity calculating section 161 calculates the dependee similarity 16111.

In S1312, the similarity calculating section 161 determines whether or not the two dependency types agree, and whether or not the two dependee elements agree, for the obtained dependency data combinations.

When the dependency types or the dependee elements disagree with each other, it is indicated that the dependency data combinations disagree with each other. The process then proceeds to S1313.

When both the dependency types and the dependee elements agree with each other, it is indicated that the dependency data combinations agree with each other. The process then proceeds to S1314.

The dependee similarity 16111 is calculated based on the dependency elements and the dependent strength.

Referring to a combined dependency data combination at the bottom of the dependee similarity list 1611 in FIG. 8, the depender element 1 is set to “f0”, the depender element 2 is set to “f4”, the dependee element 1 is set to “a”, and the dependee element 2 is set to “a”. As discussed earlier, the dependent strength 1314 indicates how many times the depender element has referred to the dependee element. Specifically, the dependent strength 1 is set to 1 because “f0” of the depender element 1 has referred to “a” for the dependee element 2 just once, and the dependent strength 2 is set to 2 because “f4” of the depender element 2 has referred to “a” for the dependee element 2 twice. When determining agreement, the similarity calculating section 161 calculates the dependency similarity by formula 1.

“Dependee similarity”=“Minimum dependency”/“Maximum dependency” Formula 1:

In S1313, since agreement has not been determined, the similarity calculating section 161 sets the dependee similarity 16111 to 0 in the dependency similarity list 1611.

In S1314, since agreement has been determined, the similarity calculating section 161 sets the dependee similarity 16111 to the dependee similarity calculated by formula 1, in the dependee similarity list 1611.

The similarity calculating section 161 performs processing from S1311 to S1314, for every conceivable pair of dependency data combinations having different depender elements, in the dependency list 131.

Referring to a combined dependency data combination at the bottom line of the dependee similarity list 1611 in FIG. 8, both the dependee elements and the dependency types agree. In that case, the similarity calculating section 161 calculates by formula 1: “Dependee similarity”=½=0.50. As a result, the similarity calculating section 161 sets the dependee similarity 16111 to 0.50.

Referring to another combined dependency data combination at the fourth line from the bottom of the dependee similarity list 1611 in FIG. 8, the depender element 1 is set to “f0”, the depender element 2 is set to “f4”, the dependee element 1 is set to “a”, and the dependee element 2 is set to “funcA”. In this combined dependency data combination, both the dependee elements and the dependency types disagree. Therefore, the dependee similarity 16111 is set to 0.00.

<Depender Similarity Calculation Process S132>

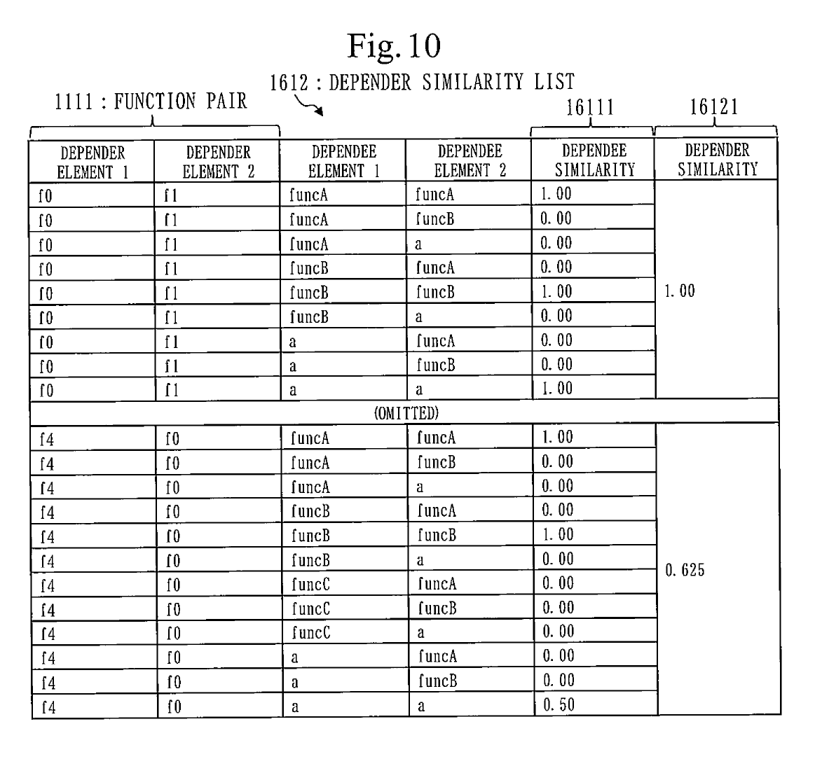

FIG. 10 illustrates an example of the depender similarity list 1612 of this embodiment.

In the depender similarity list 1612, depender element 1, depender element 2, dependee element 1, and dependee element 2 are set. The dependee similarity 16111 and the depender similarity 16121 are also set in the depender similarity list 1612. The depender similarity 16121 indicates similarity between two of the plurality of functions.

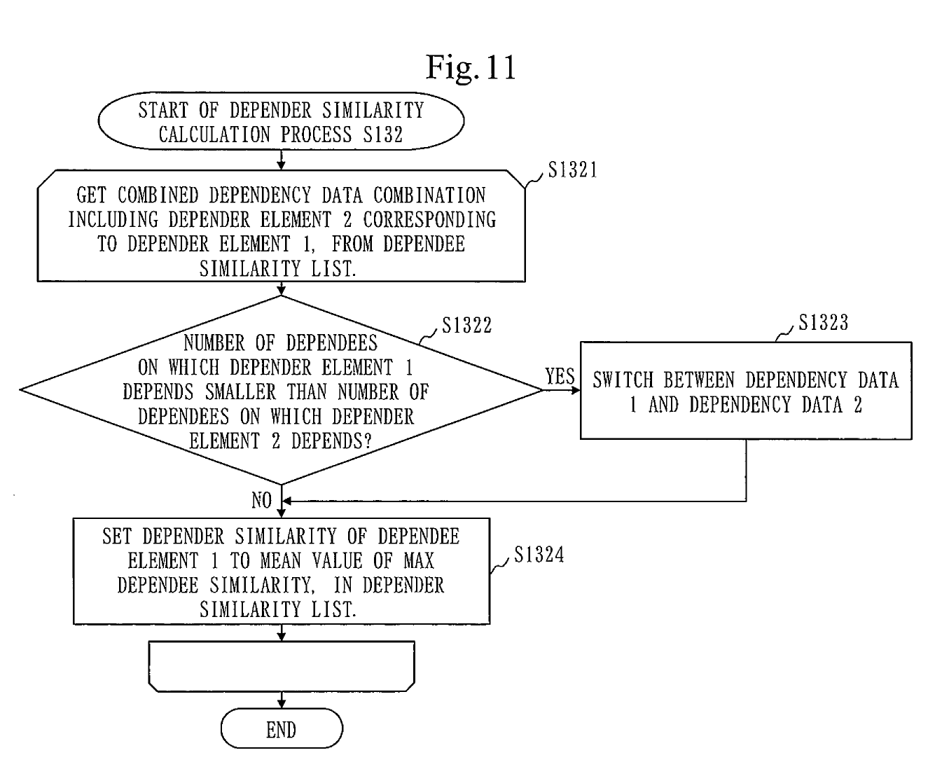

The depender similarity calculation process S132 performed by the similarity calculating section 161 of this embodiment is described below with reference to FIG. 11.

In S1321, the similarity calculating section 161 gets a combined dependency data combination including one depender element 2 corresponding to one depender element 1 in the dependee similarity list 1611.

In S1322, the similarity calculating section 161 determines whether or not the number of dependees on which the depender element 1 depends is smaller than the number of dependees on which the depender element 2 depends.

When the number of dependees on which the depender element 1 depends is equal or exceeds the number of dependees on which the depender element 2 depends (No at S1322), the process then proceeds to S1324.

When the number of dependees on which the depender element 1 depends is smaller than the number of dependees on which the depender element 2 depends (YES at S1322), the process then proceeds to S1323.

In S1323, in order to bring the maximum value of the depender similarity to 1.00, the similarity calculating section 161 switches between dependency data 1 and dependency data 2 so that the number of dependees on which the dependency data 1 depends is always larger than the number of dependees on which the dependency data 2 depends. It is to be noted that the dependency data 1 indicates data listed in columns of the depender element 1 and the dependee element 1, and the dependency data 2 indicates data listed in columns of the depender element 2 and the dependee element 2, in FIG. 10. Referring to combined dependency data combinations having a pair of “f0” of the depender element 1 and “f4” of the depender element 2, in FIG. 8, “ID” depends on three kinds of dependee elements and “f4” depends on four kinds of dependee elements. Since “f4” depends on a larger number of dependee elements, the dependency data 1 and the dependency data 2 have been switched in FIG. 10. In the case of combined dependency data combinations having a pair of “f0” of depender element 1 and “f1” of depender element 2, “f0” and “f1” both depend on three kinds of dependee elements. Therefore, the dependency data 1 and the dependency data 2 have not been switched in FIG. 10.

In S1324, the similarity calculating section 161 calculates a mean value of maximum dependee similarity, for the dependee element 1, as the depender similarity, and sets the depender similarity in the depender similarity list.

Thus, the depender similarity is calculated based on the dependee similarity between dependee elements corresponding to a function pair of depender elements.

Specifically, when the depender element 1 is “f4” and the depender element 2 is “f0”, the depender similarity 16121 is described as follows. Maximum values of dependee elements “funcA”, “funcB”, “funcC” and “a” corresponding to the depender element 1 are 1.00, 1.00, 0.00 and 0.50, respectively. These values are averaged to determine the depender similarity 16121 to be 0.625.

<Metrics Similarity Calculation Process S133>

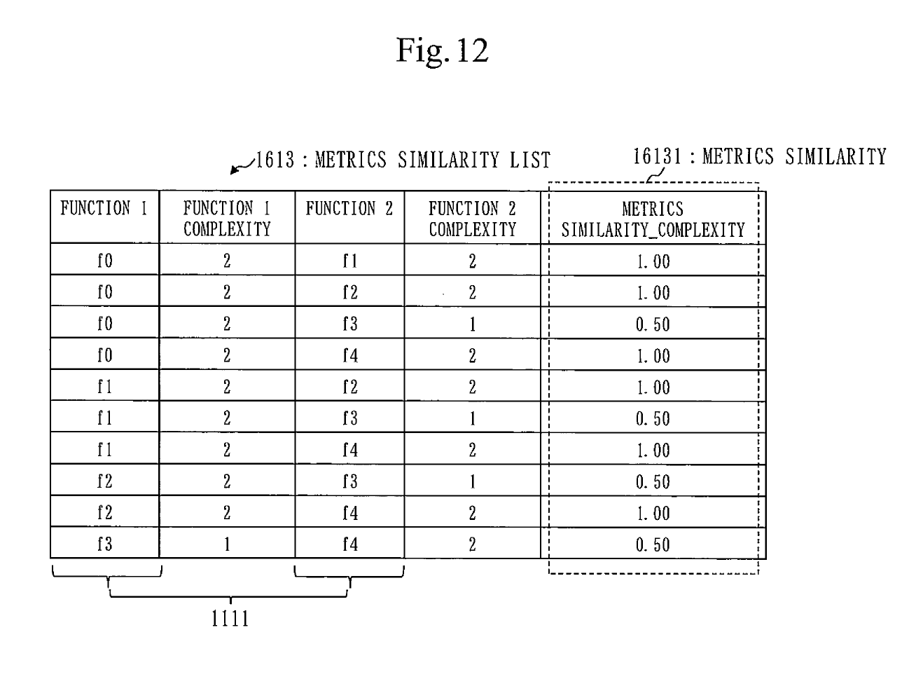

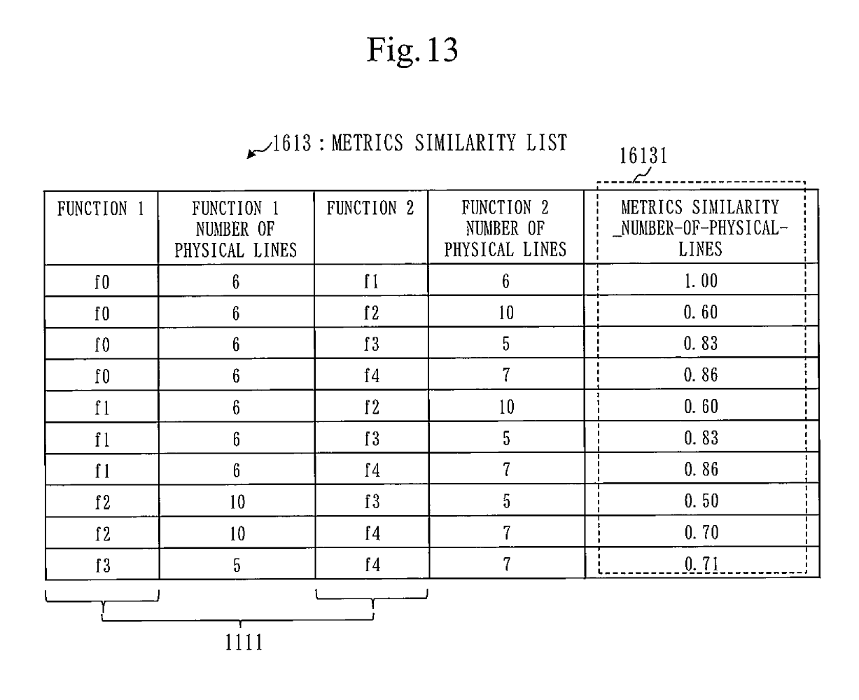

FIGS. 12 and 13 illustrate examples of the metrics similarity list 1613 of this embodiment.

The metrics similarity list 1613 includes a pair of functions of different kinds, a metrics value of each function, and metrics similarity. Referring to the metrics similarity list 1613, function 1, a metrics value of the function 1, function 2, a metrics value of the function 2, and the metrics similarity 16131 are set.

FIG. 12 shows that the metrics indicate the complexity of a function. FIG. 13 shows that the metrics indicate the number of physical lines of a function. In this embodiment, the metrics similarity list 1613 is generated for each of the two kinds of metrics, the complexity and the number of physical lines.

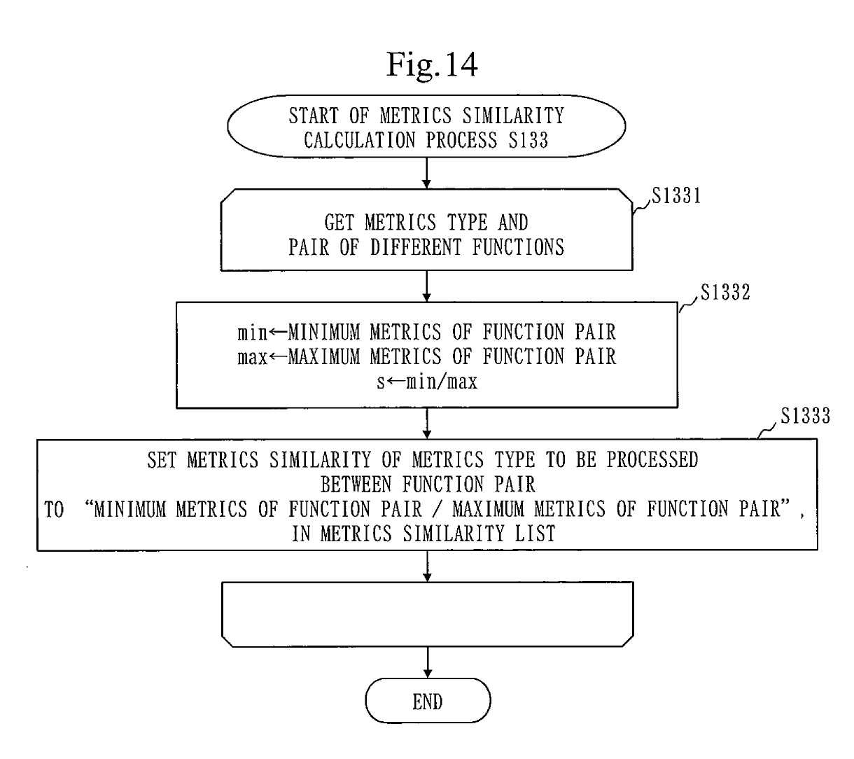

FIG. 14 is a flow chart illustrating the metrics similarity calculation process S133 performed by the similarity calculating section 161 of this embodiment.

The similarity calculating section 161 calculates, based on the metrics information 151, similarity between a function pair 1111 for complexity and similarity between the function pair 1111 for the number of physical lines, as the metrics similarity 16131.

In S1331, the similarity calculating section 161 gets metrics of any kind, and the function pair 1111 of different kinds of functions.

In S1332, the similarity calculating section 161 calculates the metrics similarity 16131 between the function pair 1111, by formula 2.

“Metrics similarity”=“Minimum metrics of function pair”/“Maximum metrics of function pair” Formula 2:

In S1333, the similarity calculating section 161 sets the calculated metrics similarity 16131, as metrics similarity of that kind just processed, in the metrics similarity list 1613.

As discussed above, the metrics similarity is calculated between the function pair 1111 for metrics. Referring to FIG. 12, similarity for complexity as metrics between the function pair of “f0” of the function 1 and “f2” of the function 2 is determined to be 1.00, by formula 2. Similarity for the number of physical lines as metrics between the function pair, “f0” of the function 1 and “f2” of the function 2, is calculated to be 0.60, by formula 2.

<Similarity Threshold Determination Process S134>

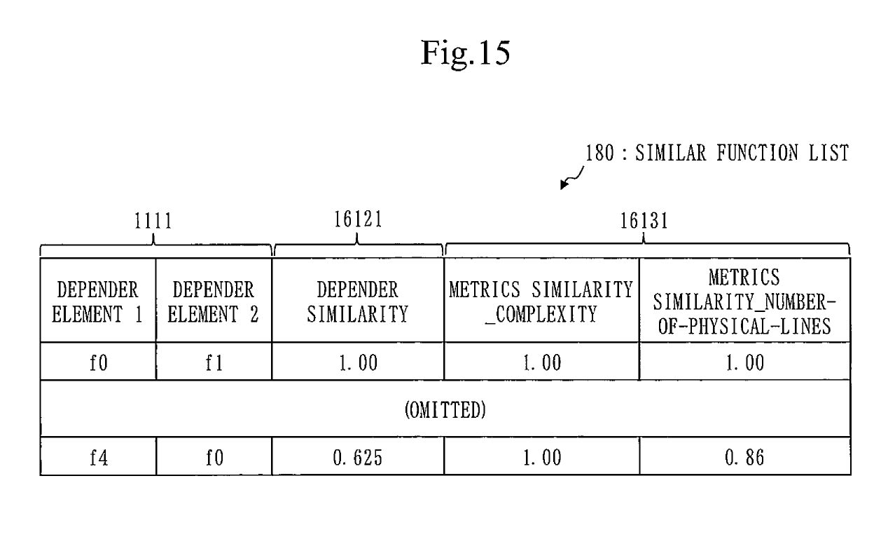

FIG. 15 illustrates an example of the similar function list 180 of this embodiment.

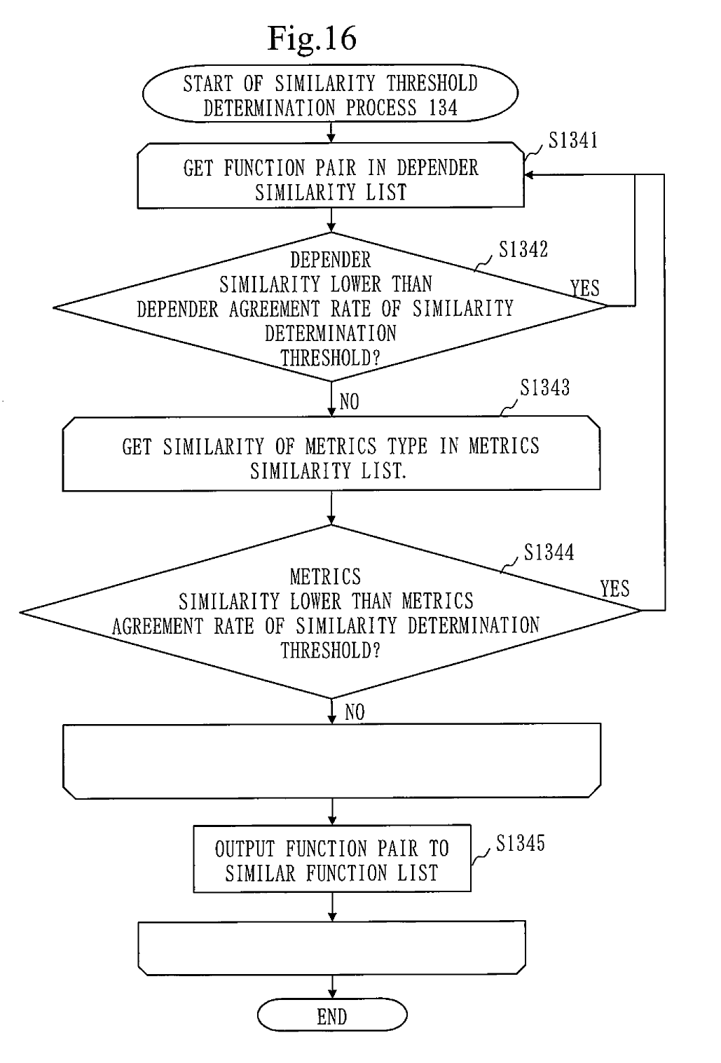

The similarity threshold determination process S134 performed by the similarity determination executing section 160 of this embodiment is discussed below with reference to FIG. 16.

In S1341, the similarity determination executing section 160 gets a function pair 1111, i.e., a pair of the depender element 1 and the depender element 2, from the depender similarity list 1612 in FIG. 10.

In S1342, the similarity determination executing section 160 determines whether or not the depender similarity 16121 between the function pair 1111 obtained at S1341 is lower than the depender agreement rate 1711 of the similarity determination threshold 171.

When the depender similarity 16121 is lower than the depender agreement rate 1711 (YES at S1342), the similarity determination executing section 160 brings the process back to S1341, and gets another function pair 1111.

When the depender similarity 16121 is equal or exceeds the depender agreement rate 1711 (NO at S1342), the similarity determination executing section 160 forwards the process to S1343.

In S1343, the similarity determination executing section 160 gets the metrics similarity 16131 of any kind in the metrics similarity list 1613, as metrics similarity to be processed. It is assumed here that the metrics similarity 16131 for complexity is obtained as the metrics similarity to be processed.

In S1344, the similarity determination executing section 160 determines whether or not the obtained metrics similarity between the function pair 1111 obtained at S1341 is lower than the metrics agreement rate 1712 of the similarity determination threshold 171.

When the obtained metrics similarity is lower than the metrics agreement rate 1712 (YES at S1344), the similarity determination executing section 160 brings the process back to S1341, and gets another function pair 1111.

When the obtained metrics similarity is equal or exceeds the metrics agreement rate 1712 (NO at S1344), and metrics similarity of the other kind has been left unprocessed, the similarity determination executing section 160 gets the unprocessed metrics similarity as the metrics similarity to be processed (S1343), and repeats the same process. When metrics similarity has been determined for every kind, the similarity determination executing section 160 forwards the process to S1345.

In S1345, the similarity determination executing section 160 outputs the function pair 1111 obtained at S1341 to the similar function list 180.

Referring to FIG. 15, the function pair 1111, the depender similarity 16121 and the metrics similarity 16131 are set in the similar function list 180. As the function pair 1111, the depender element 1 and the depender element 2 are set. As the metrics similarity 16131, the metrics similarity_complexity and the metrics similarity_number-of-physical-lines are set.

The function pair of “f4” and “f0” is described below, specifically.

Referring to FIG. 10, the depender similarity 16121 between the function pair of “f4” and “f0” is 0.625. The metrics similarity_complexity is 1.00, and the metrics similarity_number-of-physical-lines is 0.86. When compared with the similarity determination threshold 171 in FIG. 7, every one of those values is equal or exceeds the threshold. It is therefore determined that “f4” and “f0” of the pair are similar functions. Thus, as seen in FIG. 15, the function pair of “f4” and “f0” has been outputted to the similar function list 180.

***Explanation of Advantageous Effects of this Embodiment***

As discussed above, the similarity determination apparatus of this embodiment includes the dependency analyzing section that refers to the source code for dependency, and extracts the dependency list; and the metrics extracting section that refers to the source code for source code information, and extracts the metrics information. The similarity determination apparatus of this embodiment also includes the similarity determination executing section that compares the dependency list and the metrics information separately with the similarity determination threshold, and extracts the similar function list. As a result, a pair of similar functions depending on identical dependee elements may be extracted.

FIG. 3 shows comparisons between determination results obtained by the method performed by the similarity determination apparatus of this embodiment and the method performed by the comparison example.

According to the syntax-difference method performed by the comparison example for determining syntax pattern agreement between functions “f0”, “f1”, “f2”, “f3” and “f4”, it is determined that functions “f0” and “f1” agree with each other, but that “f0” and “f2” disagree because their syntaxes are different from each other.

According to the present embodiment, however, difference between functions in the dependency list is calculated as the depender similarity which is then used for similarity determination. This allows the functions “f0” and “f2” to be determined to agree with each other.

Based only on the depender similarity indicating difference in the dependency list, however, the function “f0” involving conditional branching and the function “f3” not involving conditional branching are determined to agree. To avoid such determination, difference in metrics between functions is calculated as the metrics similarity which is then used for similarity determination, according to this embodiment. This allows the functions “f0” and “f3” to be determined to disagree with each other.

The similarity determination apparatus of this embodiment performs similarity determination based on the depender similarity in conjunction with the metrics similarity. Therefore, the functions whose syntaxes are different but which perform similar processes may be extracted.

Thus, according to the similarity determination apparatus of this embodiment, not only a pair of similar code fragments having the same syntax, but also a pair of similar code fragments having different syntaxes, in a source code, may be detected. Furthermore, a pair of similar code fragments may be detected without adjusting the number of tokens.

***Alternative Configurations***

According to this embodiment, the similarity determination apparatus 100 is described as being provided with the source code storage unit 110, the dependency list storage unit 130, the metrics storage unit 150 and the similarity determination storage unit 170. However, the similarity determination apparatus 100 may not always be configured to include all of the four storage units. As an alternative example, the similarity determination apparatus 100 may be provided with part of the four storage units, and the rest of the storage units may be provided at an external storage device. It is also possible that the similarity determination apparatus 100 is configured so that all of the four storage units are provided in one or more external storage devices. Another possibility is that the similarity determination apparatus 100 is connected over a network to a storage device which stores at least part of the storage units.

### Embodiment 2

In a second embodiment, a description will be given mainly of portions that are different from those discussed in the first embodiment.

Configurations which are the same as those discussed in the first embodiment are given the same reference signs as those of the first embodiment, and may not be elaborated here.

It is customary to give a name to a function or a variable in a source code of a program so that the name reflects the feature or task of the function or the variable, for serviceability when software is developed. For this reason, functions or variables which have similar features or tasks are likely to have similar names.

In the method discussed in the first embodiment, similarity information is measured quantitatively only between the functions that depend on the dependees whose function names or variable names are identical. For this reason, the function pair depending on dependees whose function names or variable names are similar but differ slightly is reduced in similarity and cannot be detected as similar functions.

In this embodiment, a similarity determination apparatus 100a is elaborated, which is capable of detecting, by partial-matching detection of character strings based on Levenshtein Distance or the like, a function pair whose names differ slightly, but which performs similar processes, as similar functions.

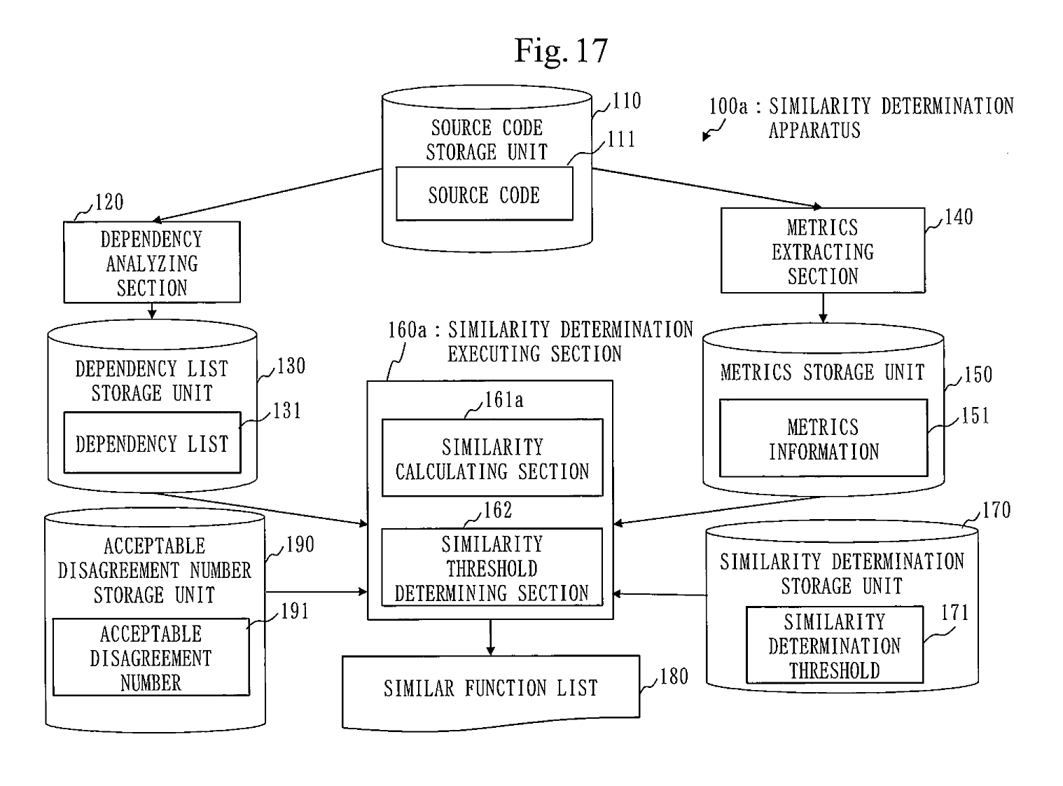

FIG. 17 illustrates a block configuration of the similarity determination apparatus 100a of this embodiment.

Referring to FIG. 17, the similarity determination apparatus 100a modifies the similarity determination apparatus 100 described in the first embodiment by adding an acceptable disagreement number storage unit 190. The acceptable disagreement number storage unit 190 stores the number of characters to allow the functions to be determined to be similar to each other, as an acceptable disagreement number 191. The acceptable disagreement number 191 is an example of a third threshold 1911.

The acceptable disagreement number storage unit 190, however, may not be included in the similarity determination apparatus 100a, and alternatively, may be included in a storage device outside the similarity determination apparatus 100a.

According to the first embodiment, the similarity calculating section 161 determines whether or not the dependency types of dependee elements agree, and whether or not the names of the dependee elements agree.

According to this embodiment, however, a similarity calculating section 161a determines that the names of dependee elements on which two functions depend are similar to each other when the number of different characters between the names of dependee elements on which two functions depend is equal or smaller than the acceptable disagreement number 191. In other words, the similarity calculating section 161a determines whether or not the dependency types of the dependee elements agree with each other, and also determines whether or not the number of different characters between the names of dependee elements is within the acceptable range.

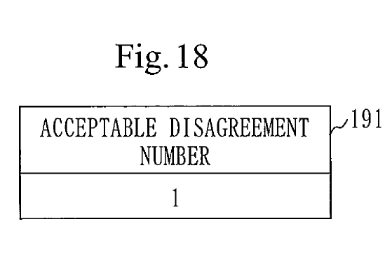

FIG. 18 illustrates an example of the acceptable disagreement number 191 of this embodiment. The acceptable disagreement number 191 is set to the number of different characters between dependee elements.

***Explanation of Operation***

Referring to the acceptable disagreement number 191 in FIG. 18, it is indicated that if the number of different characters is not more than 1, similarity is determined.

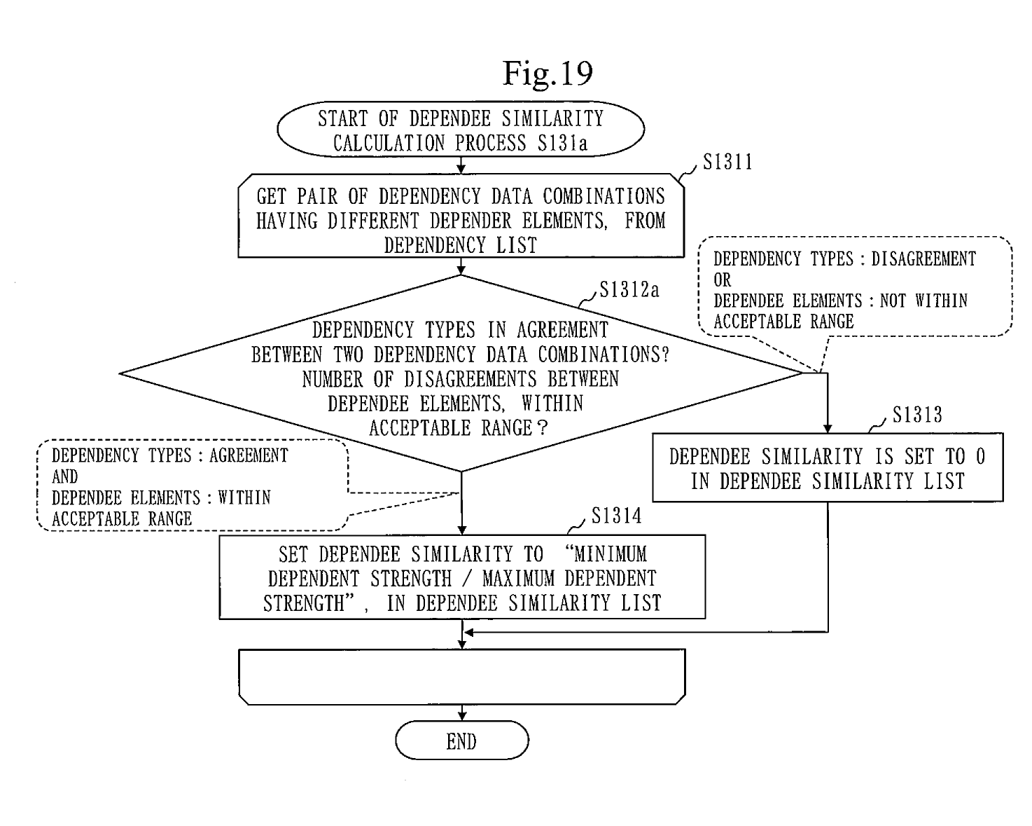

A dependee similarity calculation process S131a performed by the similarity calculating section 161a is discussed below with reference to FIG. 19.

FIG. 19 corresponds to FIG. 9 discussed in the first embodiment, which differs from FIG. 9 in a process performed in S1312a.

In S1312a, the similarity calculating section 161a determines whether or not the dependency types agree between the obtained two dependency data combinations, and whether or not the number of different characters in the names of dependee elements between the two dependency data combinations is equal or smaller than the acceptable disagreement number 191.

If the dependency types disagree, or the number of disagreements between the dependee elements is more than the acceptable disagreement number 191, it is indicated that the dependency data combinations do not agree, and therefore are not similar to each other. The process then proceeds to S1313.

If the dependency types agree, and the number of disagreements between the dependee elements is equal or smaller than the acceptable disagreement number 191, it is indicated that the dependency data combinations are identical. The process then proceeds to S1314.

The similarity calculating section 161a calculates the dependee similarity 16111, by formula 1, between dependency data combinations having different kinds of depender elements, in the dependency list 131, when the dependency types in the two dependency data combinations agree, and the number of disagreements between the dependee elements is equal or smaller than the acceptable disagreement number 191 (S1314). Otherwise, the similarity calculating section 161a sets the dependee similarity 16111 to 0 in the dependee similarity list 1611 (S1313).

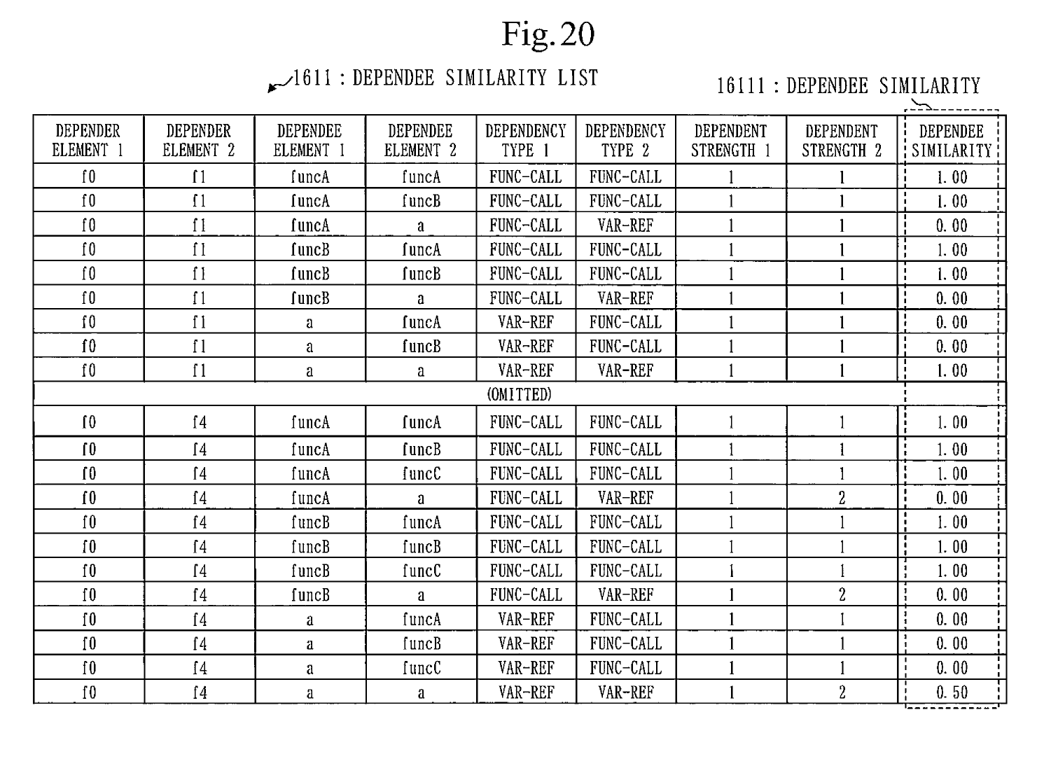

FIG. 20 illustrates the dependee similarity list 1611 of this embodiment.

A description is given more specifically with reference to the dependee similarity list 1611 in FIG. 20. Referring to a dependency data combination in the eleventh line from the bottom of the list in FIG. 20, depender element 1 is set to “f0”, depender element 2 is set to “f4”, dependee element 1 is set to “funcA”, and dependee element 2 is set to “funcB”. Dependency type 1 and dependency type 2 are both set to Function-Call, so they agree. The number of different characters between “funcA” and “funcB” is 1. Therefore, the dependee similarity 16111 is determined to be 1.00 by formula 1.

Referring to a combined dependency data combination in the fourth line from the bottom of the list in FIG. 20, the depender element 1 is set to “f0”, the depender element 2 is set to “f4”, the dependee element 1 is set to “a”, and the dependee element 2 is set to “funcA”. The dependency type 1 is set to Variable-Reference and the dependency type 2 is set to Function-Call, so they disagree. Therefore, the dependee similarity 16111 is determined to be 0.00.

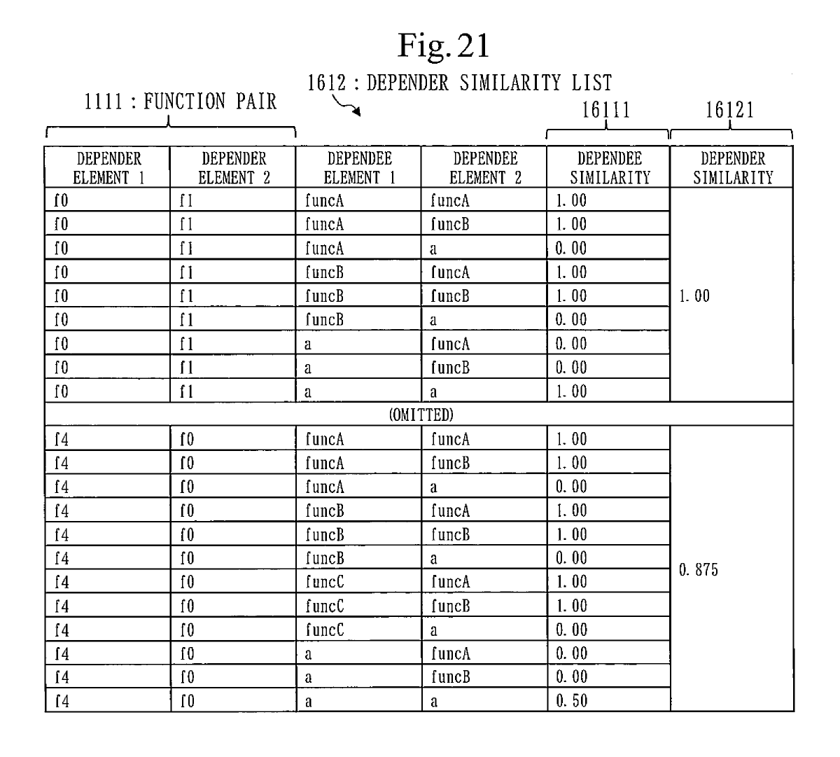

FIG. 21 illustrates an example of the depender similarity list 1612 of this embodiment.

The depender similarity 16121 according to this embodiment is discussed below with reference to the depender similarity list 1612 in FIG. 21.

When the depender element 1 is “f4” and the depender element 2 is “f0”, the value of the maximum dependee similarity of the dependee element 1, “funcA”, “funcB”, “funcC”, “a”, on which the depender element 1 depends, is 1.00, 1.00, 1.00, 0.50, respectively. This is because the maximum dependee similarity of the dependee element “funcC” is 1.00 in this embodiment whereas the maximum dependee similarity of the dependee element “funcC” is 0.00 in the first embodiment. The depender similarity 16121 is calculated by averaging those values and determined to be 0.875. Thus, similarity here is improved, compared to 0.625 of the depender similarity 16121 of the first embodiment.

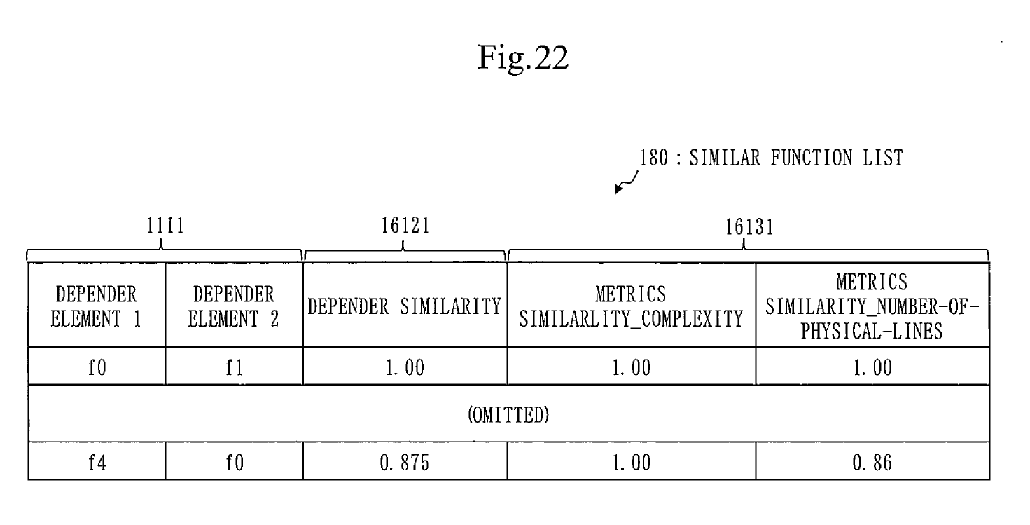

FIG. 22 illustrates an example of the similar function list 180 of this embodiment.

Referring to FIG. 22, the depender similarity 16121 between the function pair of “f4” and “f0” is 0.875. The metrics similarity_complexity is 1.00, and the metrics similarity_number-of-physical-lines is 0.86. These values are compared with the similarity determination threshold 171 of FIG. 7 to find that they exceed the thresholds. Therefore, it is determined that the function pair of “f4” and “f0” is a pair of similar functions. Thus, the function pair of “f4” and “f0” has been outputted to the similar function list 180 as seen in FIG. 22.

***Explanation of Advantageous Effects of this Embodiment***

As discusses above, the similarity determination apparatus of this embodiment allows the function pair whose names differ slightly but which perform similar processes to be detected as similar functions.

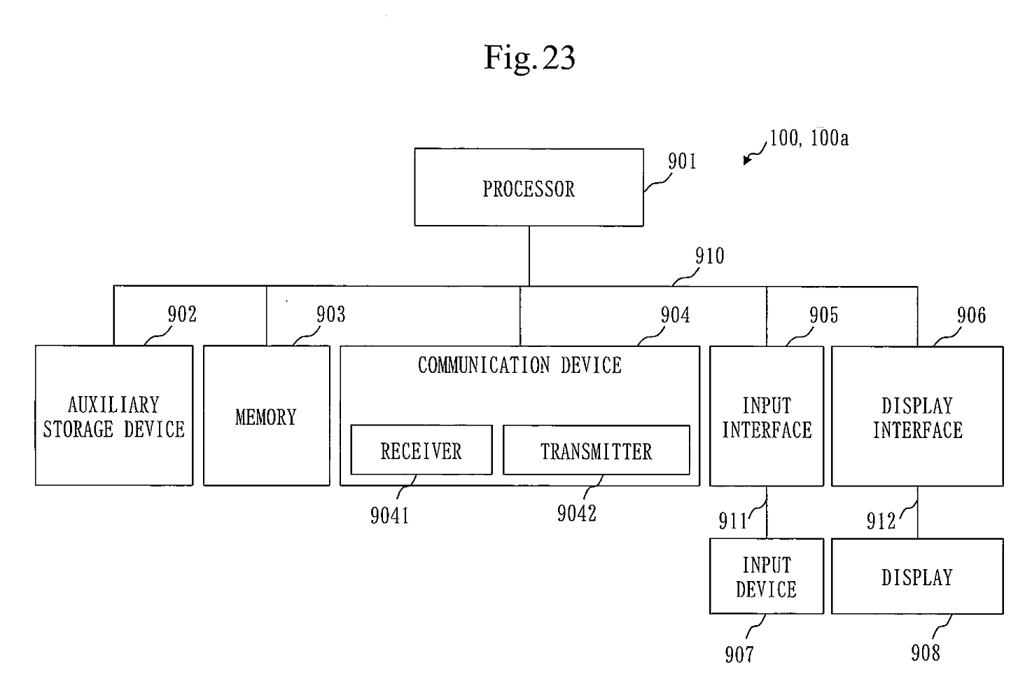

An example of a hardware configuration for the similarity determination apparatus 100 of the first embodiment and the similarity determination apparatus 100a of the second embodiment, is discussed below with reference to FIG. 23.

The similarity determination apparatus 100, 100a is a computer.

The similarity determination apparatus 100, 100a is provided with hardware such as a processor 901, an auxiliary storage device 902, a memory 903, a communication device 904, an input interface 905 and a display interface 906.

The processor 901 is connected to other hardware devices via a signal line 910 to control the hardware devices.

The input interface 905 is connected to an input device 907.

The display interface 906 is connected to a display 908.

The processor 901 is an integrated circuit (IC) to perform processing.

Specifically, the processor 901 is a CPU, a DSP (Digital Signal Processor) or a GPU.

The auxiliary storage device 902 is a read only memory (ROM), a flash memory or a hard disk drive (HDD).

The memory 903 is a random access memory (RAM).

The communication device 904 includes a receiver 9041 to receive data, and a transmitter 9042 to transmit data.

Specifically, the communication device 904 is a communication chip or a network interface card (NIC).

The input interface 905 is a port to which a cable 911 of the input device 907 is connected.

Specifically, the input interface 905 is a universal serial bus (USB) terminal.

The display interface 906 is a port to which a cable 912 of the display 908 is connected.

Specifically, the display interface 906 is a USB terminal or a high definition multimedia interface (HDMI: Registered Trademark) terminal.

The input device 907 is a mouse, a keyboard or a touch panel.

The display 908 is a liquid crystal display (LCD).

The auxiliary storage device 902 stores programs to implement the functions of the dependency analyzing section, the metrics extracting section, the similarity calculating section and the similarity determination executing section 160 in FIGS. 1 and 17. Hereafter, the dependency analyzing section, the metrics extracting section, the similarity calculating section and the similarity determination executing section 160 are referred to generically as the term “section”.

A program to implement the function of the “section” is referred to also as the similarity determination program 9200. The program to implement the function of the “section” may be a single program, or composed of a plurality of programs. The program to implement the function of the “section” is stored in a storage medium such as a magnetic disk, a flexible disk, an optical disk, a compact disk, a Blue Ray (Registered Trademark) disk, or a DVD.

This program is loaded to the memory 903, and read and executed by the processor 901.

The auxiliary storage device 902 also stores an operating system (OS).

At least part of the OS is loaded to the memory 903, and the processor 901 executes the program to implement the function of the “section” while executing the OS.

FIG. 23 shows only one processor 901. Alternatively, however, the similarity determination apparatus 100 may be provided with a plurality of processors 901.

In that case, the plurality of processors 901 may execute the program to implement the function of the “section” in conjunction with each other.

Information, data, a signal value or a variable value, indicating a result of a process by the “section”, is stored in the memory 903, the auxiliary storage device 902, or a register or a cache memory provided in the processor 901, as a file.

The “section” may be replaced by “processing circuitry”.

Further, the term “section” may read a “circuit”, a “step”, a “procedure” or a “process”. Additionally, the term “process” may read a “circuit”, a “step”, a “procedure” or a “section”.

“Circuit” and “processing circuitry” are terms that have a concept including not only the processor 901 but also other types of processing circuitry such as a logic IC, a gate array (GA), an application specific integrated circuit (ASIC) and a field-programmable gate array (FPGA).

What is called a program product is a storage medium or a storage device which stores the program to implement the function described as the “section”. The program product loads a computer readable program, regardless of the visual format.

According to the embodiments discussed above, each “section” is an independent function block which composes the similarity determination apparatus 100. Alternatively, however, the similarity determination apparatus 100 may be configured differently from that described. The similarity determination apparatus 100 may have any configuration.

The dependency analyzing section and the metrics extracting section may be integrated into a single function block. The similarity calculating section and the similarity determination executing section 160 may also be integrated into a single function block. As long as the functions described in the embodiments can be successfully implemented, the similarity determination apparatus 100 may be configured with any function block. The similarity determination apparatus 100 may be configured with any combination of those function blocks, or may have any block configuration, other than those discussed.

Alternatively, the similarity determination apparatus may be composed of a plurality of devices, instead of a single device.

Of the two embodiments 1 and 2 discussed above, parts of the embodiments may be implemented together, or alternatively one of the embodiments may be implemented partially. It is also possible that these embodiments may be implemented, wholly or partially, in any combination thereof.

The embodiments discussed herein are essentially preferable examples. It is not intended that these embodiments limit the scope of the present invention, its application, and its use. The embodiments may be varied where necessary.

Numerous additional modifications and variations are possible in light of the above teachings. It is therefore to be understood that, within the scope of the appended claims, the disclosure of this patent specification may be practiced otherwise than as specifically described herein.

### REFERENCE SIGNS LIST

100, 100a similarity determination apparatus
110 source code storage unit
111 source code
1111 function pair
112 property
113 detection result
120 dependency analyzing section
130 dependency list storage unit
131 dependency list
1311 depender element
1312 dependee element
1313 dependency type
1314 dependent strength
140 metrics extracting section
150 metrics storage unit
151 metrics information
1511 complexity
1512 physical line number
160 similarity determination executing section
161, 161a similarity calculating section
1611 dependee similarity list
1612 depender similarity list
1613 metrics similarity list
16111 dependee similarity
16121 depender similarity
16131 metrics similarity
162 similarity threshold determining section
170 similarity determination storage unit
171 similarity determination threshold
1711 depender agreement rate
1712, 1713 metrics agreement rate
17111 first threshold
17121 second threshold
190 acceptable disagreement number storage unit
191 acceptable disagreement number
1911 third threshold
180 similar function list
901 processor
902 auxiliary storage device
903 memory
904 communication device
905 input interface
906 display interface
907 input device
908 display
910 signal line
911, 912 cable
9041 receiver
9042 transmitter
9100 similarity determination method
9200 similarity determination program
S100 similarity determination process
S110 dependency analysis process
S120 metrics extraction process
S130 similarity determination execution process
S1301 similarity calculation process
S134 similarity threshold determination process

1. A similarity determination apparatus comprising:
a dependency analyzer to get a list of dependee elements as a dependency list, from a source code including a plurality of functions, each of the plurality of functions depending on one of the dependee elements;
a similarity calculator to:
calculate, based on the dependency list, similarity between dependee elements on which two of the plurality of functions depend, as dependee similarity, and
calculate, based on the dependee similarity, similarity between the two functions, as depender similarity; and
a similarity threshold determiner to determine that the two functions are similar to each other when the depender similarity is equal or exceeds a first threshold.

2. The similarity determination apparatus of claim 1 further comprising:
a metrics extractor to extract, from the source code, metrics which indicate a quantified property of one of the plurality of functions, as metrics information;
wherein:
the similarity calculator calculates, based on the metrics information, the similarity between the two functions for the property, as metrics similarity; and
the similarity threshold determiner determines that the two functions are similar to each other when the depender similarity is equal or exceeds the first threshold, and the metrics similarity is equal or exceeds a second threshold.

3. The similarity determination apparatus of claim 2,
wherein:
the metrics extractor extracts from the source code the metrics information including complexity and a number of physical lines, of the one of the plurality of functions; and
the similarity calculator calculates, based on the metrics information, the similarity between the two functions for the complexity, and the similarity between the two functions for the number of physical lines, as the metrics similarity.

4. The similarity determination apparatus of claim 1,
wherein:
the dependency analyzer gets the dependency list including:
a dependee element on which one of the plurality of functions depends;
a dependency type indicating a type of the dependee element; and
a dependent strength indicating a level of dependency of the one of the plurality of functions depending on the dependee element; and
the similarity calculator:
determines whether or not names of the dependee elements are similar between the two functions,
determines whether or not dependency types agree between the two functions, and
calculates the dependee similarity based on determination results and the dependent strength.

5. The similarity determination apparatus of claim 4, wherein the similarity calculator determines that the names of the dependee elements are similar between the two functions when a number of different characters between the names of the dependee elements on which the two functions depend is equal or smaller than a third threshold.

6. A similarity determination method comprising:
getting a list of dependee elements as a dependency list, from a source code including a plurality of functions, each of the plurality of functions depending on one of the dependee elements;
calculating, based on the dependency list, similarity between dependee elements on which two of the plurality of functions depend, as dependee similarity;
calculating, based on the dependee similarity, similarity between the two functions, as depender similarity; and
determining that the two functions are similar to each other when the depender similarity is equal or exceeds a first threshold.

7. The similarity determination method of claim 6 further comprising:
extracting, from the source code, metrics which indicate a quantified property of one of the plurality of functions, as metrics information;
calculating, based on the metrics information, the similarity between the two functions for the property, as metrics similarity; and
determining that the two functions are similar to each other when the depender similarity is equal or exceeds the first threshold, and the metrics similarity is equal or exceeds a second threshold.

8. A similarity determination program causing a computer to execute:
a dependency analysis process to get a list of dependee elements as a dependency list, from a source code including a plurality of functions, each of the plurality of functions depending on one of the dependee elements;
a similarity calculation process to:
calculate, based on the dependency list, similarity between dependee elements on which two of the plurality of functions depend, as dependee similarity, and calculate, based on the dependee similarity, similarity between the two functions, as depender similarity; and
a similarity threshold determination process to determine that the two functions are similar to each other when the depender similarity is equal or exceeds a first threshold.

9. The similarity determination program of claim 8 further comprising:
a metrics extraction process to extract, from the source code, metrics which indicate a quantified property of one of the plurality of functions, as metrics information;
wherein:
the similarity calculation process calculates, based on the metrics information, the similarity between the two functions for the property, as metrics similarity; and
the similarity threshold determination process determines that the two functions are similar to each other when the depender similarity is equal or exceeds the first threshold, and the metrics similarity is equal or exceeds a second threshold.
